(19) United States
(12) Patent Application Publication
(10) Pub. No.: US 2006/0111242 A1
(43) Pub. Date: May 25, 2006

(54) Powder formulations

(76) Inventors: Hanns-Peter Muller, Odenthal (DE); Horst Gruttmann, Leverkusen (DE); Hilmar Wolf, Langenfeld (DE); Anne Suty-Heinze, Langenfeld (DE); Uwe Priesnitz, Solingen (DE)

Correspondence Address: BAYER CROPSCIENCE LP;Patent Department, 100 BAYER ROAD, PITTSBURGH, PA, 15205-9741, US

(21) Appl. No.: 10/517,504

(22) PCT Filed: May 30, 2003
(86) PCT No.: PCT/EP03/05706

§ 371 Date: Aug. 8, 2005

(30) Foreign Application Priority Data
Jun. 13, 2002 (DE) 102 26 222.5

(51) Int. Cl. A01N 25/10

(52) U.S. Cl. 504/361

(57) ABSTRACT

New powder formulations consisting of at least one agrochemical active compound, at least one copolymer of styrene and acrylonitrile with an acrylonitrile content of between 20 and 40% by weight, and, if appropriate, additives and which have a particle diameter of under 125 μm, a process for the preparation of the new powder formulations, and their use for applying agrochemical active compounds to plants and/or their environment.

The present invention relates to new powder formulations comprising agrochemical active compounds and polymers, to a process for the preparation of these formulations, and to their use for applying agrochemical active compounds.

Microparticles containing specific polymers as a mixture with agrochemical active compounds are also known from WO 99-00 013. These preparations are made by dissolving polymers and agrochemical active compounds in an organic solvent which is sparingly miscible with water, then dispersing this solution in water using emulsifiers, thereupon evaporating the solvent, and separating the resulting microparticles from the aqueous phase by decanting and/or filtration and subsequently drying them. However, the disadvantage of this process is that a large number of complicated procedures have to be carried out and thus the use of relatively large apparatuses is necessary when carrying out the process on an industrial scale. The fact that the organic solvents required for dissolving the components must subsequently be removed is additionally disadvantageous.

Furthermore, U.S. Pat. No. 5,725,865 also describes methods for the preparation of polymer microparticles in which agrochemical active compounds are present. Again, these methods are very complicated and therefore hardly suitable for use on an industrial scale.

There have now been found new powder formulations consisting of
at least one agrochemical active compound,
at least one copolymer of styrene and acrylonitrile with an acrylonitrile content of between 20 and 40% by weight, and,
if appropriate, additives

and which have a particle diameter of under 125 μm.

It has furthermore been found that the powder formulations according to the invention can be prepared by homogenizing a mixture of
at least one agrochemical active compound,
at least one copolymer of styrene and acrylonitrile with an acrylonitrile content of between 20 and 40% by weight, and,
if appropriate, additives

at temperatures of between 120° C. and 230° C. in the melt and comminuting the mixture after cooling in such a way as to obtain a powder in which the particles have a diameter under 125 μm.

Finally, it has been found that the powder formulations according to the invention are highly suitable for applying the agrochemical active compounds which they contain to plants and/or their environment.

It must be considered as extremely surprising that the powder formulations according to the invention are more suitable for applying the agrochemical active compounds which they contain than the prior-art preparations of the most similar constitution. What is particularly unexpected is that the active components are released in the specifically desired amount over a prolonged period.

Furthermore, it had to be assumed that carrying out the process according to the invention would, after cooling of the melt, result in soft resins which are sticky at room temperature since mixtures of agrochemical active compounds and copolymers of styrene and acrylonitrile generally have low melting points. However, in contrast to what was expected, products are obtained which are so brittle that they can be comminuted with the aid of customary mills without additional cooling to give free-flowing powders which do not form aggregates.

The powder formulations according to the invention contain one or more agrochemical active compounds.

Agrochemical active compounds are understood as meaning, for the present purpose, all substances which are customary for the treatment of plants. Substances which may preferably be mentioned are fungicides, bactericides, insecticides, acaricides, nematicides, herbicides, plant growth regulators, plant nutrients and repellents. Solid agrochemical active compounds are preferred.

Examples of fungicides which may be mentioned are:

2-anilino-4-methyl-6-cyclopropylpyrimidine; 2′,6′-dibromo-2-methyl-4′-trifluoromethoxy-4-trifluoromethyl-1,3-thiazole-5-carboxanilide; 2,6-dichloro-N-(4-trifluoromethylbenzyl)benzamide; (E)-2-methoximino-N-methyl-2-(2-phenoxyphenyl)-acetamide; 8-hydroxyquinoline sulphate; methyl (E)-2-(2-[6-(2-cyanophenoxy)-pyrimidin-4-yloxy]phenyl }-3-methoxyacrylate; methyl (E)-methoximino[alpha-(o-tolyloxy)-o-tolyl]acetate; 2-phenylphenol (OPP), aldimorph, ampropylfos, anilazin, azaconazole,

benalaxyl, benodanil, benomyl, binapacryl, biphenyl, bitertanol, blasticidin-S, bromuconazole, bupirimate, buthiobate,

calcium polysulphide, captafol, captan, carbendazim, carboxin, quinomethionate, chloroneb, chloropicrin, chlorothalonil, chlozolinate, cufraneb, cymoxanil, cyproconazole, cyprofuram, carpropamid,

dichlorophen, diclobutrazol, dichlofluanid, diclomezine, dicloran, diethofencarb, difenoconazole, dimethirimol, dimethomorph, diniconazole, dinocap, diphenylamine, dipyrithion, ditalimfos, dithianon, dodine, drazoxolon,

edifenphos, epoxyconazole, ethirimol, etridiazole,

fenarimol, fenbuconazole, fenfuram, fenitropan, fenpiclonil, fenpropidin, fenpropimorph, fentin acetate, fentin hydroxide, ferbam, ferimzone, fluazinam, fludioxonil, fluoromide, fluquinconazole, flusilazole, flusulfamide, flutolanil, flutriafol, folpet, fosetyl-aluminium, fthalide, fuberidazol, furalaxyl, furmecyclox, fenhexamid,

guazatine,

hexachlorobenzene, hexaconazole, hymexazol,

imazalil, imibenconazole, iminoctadine, iprobenfos (IBP), iprodione, isoprothiolan, iprovalicarb,

kasugamycin, copper preparations such as: copper hydroxide, copper naphthenate, copper oxychloride, copper sulphate, copper oxide, oxine-copper and bordeaux-mixture,

mancopper, mancozeb, maneb, mepanipyrim, mepronil, metalaxyl, metconazole, methasulfocarb, methfuroxam, metiram, metsulfovax, myclobutanil,

nickel dimethyldithiocarbamate, nitrothal-isopropyl, nuarimol,

ofurace, oxadixyl, oxamocarb, oxycarboxin,

pefurazoate, penconazole, pencycuron, phosdiphen, pimaricin, piperalin, polyoxin, probenazole, prochloraz, procymidon, propamocarb, propiconazole, propineb, pyrazophos, pyrifenox, pyrimethanil, pyroquilon,

quintozene (PCNB), quinoxyfen,

sulfur and sulfur preparations, spiroxamine,

tebuconazole, tecloftalam, tecnazene, tetraconazole, thiabendazole, thicyofen, thiophanate-methyl, thiram, tolclophos-methyl, tolylfluanid, triadimefon, triadimenol, triazoxide, trichlamide, tricyclazole, tridemorph, triflumizole, triforine, triticonazole, trifloxystrobin,

validamycin a, vinclozolin,

zineb, ziram, and

2-[2-(1-chlorocyclopropyl)-3-(2-chlorophenyl)-2-hydroxypropyl]-2,4-dihydro-[1,2,4]-triazole-3-thione.

Examples of bactericides which may be mentioned are:

bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulphate and other copper preparations.

Examples of insecticides, acaridices and nematicides which may be mentioned are:

abamectin, acephate, acetamiprid, acrinathrin, alanycarb, aldicarb, alphamethrin, amitraz, avermectin, AZ 60541, azadirachtin, azinphos A, azinphos M, azocyclotin, Bacillus thuringiensis, 4-bromo-2-(4-chlorophenyl)-1-(ethoxymethyl)-5-(trifluoromethyl)-1H-pyrrole-3-carbonitrile, bendiocarb, benfuracarb, bensultap, betacyfluthrin, bifenthrin, BPMC, brofenprox, bromophos A, bufencarb, buprofezin, butocarboxin, butylpyridaben,

cadusafos, carbaryl, carbofuran, carbophenothion, carbosulfan, cartap, chloethocarb, chloretoxyfos, chlorfenvinphos, chlorfluazuron, chlormephos, N-[(6-chloro-3-pyridinyl)-methyl]-N′-cyano-N-methyl-ethanimidamide, chlorpyrifos, chlorpyrifos M, cis-resmethrin, clocythrin, clofentezine, clothianidin, cyanophos, cycloprothrin, cyfluthrin, cyhalothrin, cyhexatin, cypermethrin, cyromazine,

deltamethrin, demeton-M, demeton-S, demeton-S-methyl, diafenthiuron, diazinon, dichlofenthion, dichlorvos, dicliphos, dicrotophos, diethion, diflubenzuron, dimethoate,

dimethylvinphos, dioxathion, disulfoton,

emamectin, esfenvalerate, ethiofencarb, ethion, ethofenprox, ethoprophos, etrimphos, fenamiphos, fenazaquin, fenbutatin oxide, fenitrothion, fenobucarb, fenothiocarb, fenoxycarb, fenpropathrin, fenpyrad, fenpyroximate, fenthion, fenvalerate, fipronil, fluazuron, flucycloxuron, flucythrinate, flufenoxuron, flufenprox, fluvalinate, fonophos, fornothion, fosthiazate, fubfenprox, furathiocarb,

HCH, heptenophos, hexaflumuron, hexythiazox,

imidacloprid, iprobenfos, isazophos, isofenphos, isoprocarb, isoxathion, ivermectin, lambda-cyhalothrin, lufenuron,

malathion, mecarbam, mevinphos, mesulfenphos, metaldehyde, methacrifos, methamidophos, methidathion, methiocarb, methomyl, metolcarb, milbemectin, monocrotophos, moxidectin,

naled, NC 184, nitenpyram,

omethoate, oxamyl, oxydemethon M, oxydeprofos,

parathion A, parathion M, permethrin, phenthoate, phorate, phosalone, phosmet, phosphamidon, phoxim, pirimicarb, pirimiphos M, pirimiphos A, profenophos, promecarb, propaphos, propoxur, prothiophos, prothoate, pymetrozin, pyrachlophos, pyridaphenthion, pyresmethrin, pyrethrum, pyridaben, pyrimidifen, pyriproxifen,

quinalphos,

salithion, sebufos, silafluofen, sulfotep, suiprofos,

tebufenozide, tebufenpyrad, tebupirimiphos, teflubenzuron, tefluthrin, temephos, terbam, terbufos, tetrachlorvinphos, thiacloprid, thiafenox, thiamethoxam, thiodicarb, thiofanox, thiomethon, thionazin, thuringiensin, tralomethrin, transfluthrin, triarathen, triazophos, triazuron, trichlorfon, triflumuron, trimethacarb,

vamidothion, XMC, xylylcarb, zetamethrin.

Examples of herbicides which may be mentioned are:

anilides such as, for example, diflufenican and propanil; arylcarboxylic acids, such as, for example, dichloropicolinic acid, dicamba and picloram; aryloxyalkanoic acids such as, for example, 2,4-D, 2,4-DB, 2,4-DP, fluroxypyr, MCPA, MCPP and triclopyr; aryloxyphenoxyalkanoic esters such as, for example, diclofop-methyl, fenoxaprop-ethyl, fluazifop-butyl, haloxyfop-methyl and quizalofop-ethyl; azinones such as, for example, chloridazon and norflurazon; carbamates such as, for example, chlorpropham, desmedipham, phenmedipham and propham; chloroacetanilides such as, for example, alachlor, acetochlor, butachlor, metazachlor, metolachlor, pretilachlor and propachlor; dinitroanilines such as, for example, oryzalin, pendimethalin and trifluralin; diphenyl ethers such as, for example, acifluorfen, bifenox, fluoroglycofen, fomesafen, halosafen, lactofen and oxyfluorofen; ureas such as, for example, chlortoluron, diuron, fluometuron, isoproturon, linuron and methabenzthiazuron; hydroxylamines such as, for example, alloxydim, clethodim, cycloxydim, sethoxydim and tralkoxydim; imidazolinones such as, for example, imazethapyr, imazamethabenz, imazapyr and imazaquin; nitriles such as, for example, bromoxynil, dichlobenil and ioxynil; oxyacetamides such as, for example, mefenacet; sulphonylureas such as, for example, aridosulfuron, bensulfuron-methyl, chlorimuron-ethyl, chlorsulfuron, cinosulfuron, metsulfuron-methyl, nicosulfuron, primisulfuron, pyrazosulfuron-ethyl, thifensulfuron-methyl, triasulfuron and tribenuron-methyl; thiocarbamates such as, for example, butylate, cycloate, di-allate, EPTC, esprocarb, molinate, prosulfocarb, thiobencarb and tri-allate; triazines such as, for example, atrazine, cyanazine, simazine, simetryne, terbutryne and terbutylazine; triazinones such as, for example, hexazinon, metamitron and metribuzin; others such as, for example, aminotriazole, benfuresate, bentazone, cinmethylin, clomazone, clopyralid, difenzoquat, dithiopyr, ethofumesate, fluorochloridone, glufosinate, glyphosate, isoxaben, pyridate, quinchlorac, quinmerac, sulphosate and tridiphane. Others which may be mentioned are 4-amino-N-(1,1-dimethylethyl)-4,5-dihydro-3-(1-metylethyl)-5-oxo-1H-1,2,4-triazole-1-carboxamide and methyl 2-((((4,5-dihdydro-4-methyl-5-oxo-3-propoxy-1H-1,2,4-triazol-1-yl)carbonyl)amino)sulphonyl)benzoate.

Examples of plant growth regulators which may be mentioned are chlorcholin chloride and ethephon.

Examples of plant nutrients which may be mentioned are customary inorganic or organic fertilizers for providing plants with macro- and/or micronutrients.

Examples of repellents which may be mentioned are diethyltoluamide, ethylhexanediol and butopyronoxyl.

Examples which may be mentioned of insecticides which may preferably be present in the powder formulations according to the invention are the following active compounds:

imidacloprid, thiacloprid, thiamethoxam, acetamiprid, clothianidin, betacyfluthrin, cypermethrin, transfluthrin, lambda-cyhalothrin and azinphos-methyl.

Examples which may be mentioned of herbicides which can preferably be present in the powder formulations according to the invention are the following active compounds:

propoxycarbazone-sodium, flucarbazone-sodium, amicarbazone, dichlobenil and phenyluracils of the formula

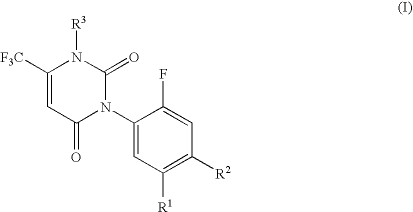

in which the substituents R¹, R² and R³ have the meanings stated hereinbelow.

TABLE 1

| R¹ | R² | R³ |
|---|---|---|
| 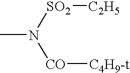 | —CN | —CH₃ |
| 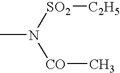 | —CN | —CH₃ |
| 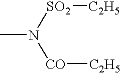 | —CN | —CH₃ |
| 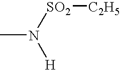 | 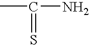 | —CH₃ |
| 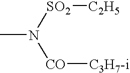 | —CN | —CH₃ |
| 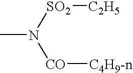 | —CN | —CH₃ |
| 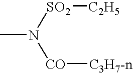 | —CN | —CH₃ |
| 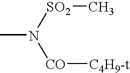 | —CN | —CH₃ |
| 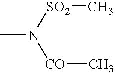 | —CN | —CH₃ |
| 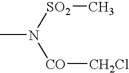 | —CN | —CH₃ |
| 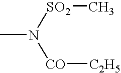 | —CN | —CH₃ |
| 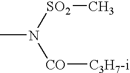 | —CN | —CH₃ |
| 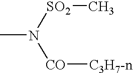 | —CN | —CH₃ |
| 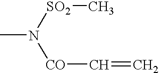 | —CN | —CH₃ |
| 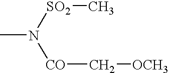 | —CN | —CH₃ |
| 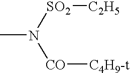 | —CN | —NH₂ |
| 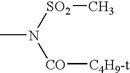 | —CN | —NH₂ |

The powder formulations according to the invention contain one or more copolymers of styrene and acrylonitrile, the acrylonitrile content being between 20 and 40% by weight. Preferred are such copolymers with an acrylonitrile content of between 25 and 35% by weight.

The copolymers of styrene and acrylonitrile which are present in the powder formulations according to the invention are known under the name SAN polymers (cf. Kunstoffe 85, 1550 (1995); Encycl. Polym. Sci. Eng. 1, 452-470; Encycl. Polym. Sci. Eng. 16, 38 et seq. and 72 et seq.; and Ullmanns Encyklopädie der technischen Chemie [Ullmann's Encyclopaedia of Chemical Engineering], 4th Ed., Vol. 19, pages 123-131). The preparation of styrene/acrylonitrile polymers is described, for example, in Houben-Weyl “Methoden der Organischen Chemie” [Methods in Organic Chemistry], Vol. E 20, Makromolekulare Stoffe [macromolecular substances], Subvolume. 2, p. 980 et seq., Georg Thieme Verlag, Stuttgart 1987. Copolymers with a random distribution of styrene and acrylonitrile are obtained by free-radical polymerization. The reaction is frequently initiated thermally, in particular in the case of industrial-scale polymerization in bulk or in solution, while free-radical initiators are employed when the polymerizations are carried out in suspension or in emulsion. Among these, azo compounds, in particular azobisisobutyronitrile, and, for polymerization in emulsion, potassium peroxodisulphate, are most frequently used.

The copolymerization of styrene and acrylonitrile is carried out in the laboratory in general as suspension polymerization (=bead polymerization) or as emulsion polymerization.

In the case of bead polymerization, a procedure is generally followed in which the specifically desired amounts of the components are dispersed in water at room temperature, the dispersion is then heated, with stirring, and, when the reaction has ended, cooled, and the resulting bead-shaped product is filtered off, washed and dried.

In the case of emulsion polymerization, a procedure is generally followed in which a separately prepared mixture of styrene and acrylonitrile is added to the warmed aqueous phase, an amount of 5 to 20% of this mixture first being added in one portion and the remainder, following reheating, being added dropwise over a prolonged period. When the reaction has ended, the mixture is worked up in the customary manner by separating off, washing and drying the copolymer.

When preparing SAN polymers on an industrial scale, polymerization in solution is preferred, the process preferably being carried out continuously (cf. Winnacker-Kuchler “Chemische Technologie” [Chemical Engineering) 4th Ed., Vol. 6, p. 379 et seq. (1982)). Compositions outside the azeotrope cause, in reactors with plug flow, the same problems as in batchwise procedures. Chemically uniform products which are independent of the monomer composition are obtained in a stirred vessel with continuous flow-through. A detailed description of a technical process in a stirred vessel with homogeneous mixing and continuous flow-through can be found in R. G. Müller, SRI Report No. 20, 86 (1966).

SAN polymers have a glass transition temperature of approximately 97° C. and a melting range of approximately 110-116° C.

The powder formulations according to the invention may, in addition to the pure SAN polymers, also contain copolymers of methylstyrene and acrylonitrile. These polymers too can be prepared by free-radical polymerization. More details on methylstyrene-acrylonitrile copolymers are found in “Ullmann's Encyclopedia of Industrial Chemistry” ISBN 3-527-20100-9 and ISBN 3-527-20121-1, Verlag Chemie, Weinhein, Vol. A 21, p. 616-633 (1992).

Suitable additives which may be present in the powder formulations according to the invention are all of the materials which can conventionally be employed in such polymer preparations. Preferably suitable are fillers, and lubricants, glidants and stabilizers known from polymer technology.

Examples of fillers which may be mentioned are: titanium dioxide, barium sulphate, furthermore aluminium oxides, silicas, clays, precipitated or colloidal silicon dioxide, and phosphates.

Examples of lubricants and glidants which may be mentioned are: magnesium stearate, stearic acid, talc and bentonites.

Suitable stabilizers are antioxidants and substances which protect the polymers from undesired degradation during processing.

The concentrations of the individual components in the powder formulations according to the invention can be varied within a substantial range. Thus,
the content of agrochemical active compounds is generally between 1 and 50% by weight, preferably between 5 and 40% by weight,
the content of styrene/acrylonitrile copolymers is generally between 50 and 99% by weight, preferably between 55 and 95% by weight, and
the additive content is generally between 0 and 30% by weight, preferably between 0 and 20% by weight.

When carrying out the process according to the invention, a procedure is generally followed in which styrene/acrylonitrile copolymer is melted at temperatures of between 120° C. and 230° C., preferably between 120° C. and 180° C., especially preferably between 140° C. and 170° C., and one or more agrochemical active compounds and, if appropriate, additives are then introduced with stirring. The resulting fluid and homogeneous mixture is transported to cooling belts or cooling drums with the aid of customary discharge devices. When cold, the solidified product is removed from the cooling device and crushed. The crude granules obtained are subsequently comminuted with customary grinding apparatuses and screened to give a powder in which the particles have a diameter of under 125 μm.

Suitable grinding apparatuses are all mills which are conventionally employed for such purposes. Mills which can preferably be used are pinned-disc mills, ball mills, jet mills or classifier mills, a mill which may be mentioned by way of example being an ACM 2 type mill from Hosokawa Mikropul.

The powder formulations according to the invention, as such or after addition of further formulation auxiliaries, can be employed for applying agrochemical active compounds in crop protection in agriculture, forestry or horticulture. Formulation auxiliaries which are suitable in this context are all those components which can generally be used in plant treatment compositions such as, for example, colorants, wetters, dispersants, emulsifiers, antifoams, preservatives, humectant components, antifreeze agents, secondary thickeners, solvents, and, when seed-dressing products are prepared, also stickers.

Colorants which can be employed for the further processing of the powders according to the invention as plant treatment compositions are all those colorants which are customary for such purposes. Colorants which can be used are sparingly water-soluble pigments and also water-soluble dyes. Examples which may be mentioned are those known under the names Rhodamin B, C.I.Pigment Red 112 and C.I.Solvent Red 1.

Suitable wetters which can be used for formulating the powders according to the invention are all those materials which promote wetting and which are customary for the formulation of agrochemical active compounds. Materials which can preferably be used are alkylnaphthalenesulphonates, such as diisopropylnaphthalenesulphonate or diisobutylnaphthalenesulphonate.

Dispersants and/or emulsifiers which are suitable for formulating the powders according to the invention are all those nonionic, anionic and cationic dispersants which are conventionally used in the formulation of agrochemical active compounds. Materials which can preferably be used are nonionic or anionic dispersants or mixtures of nonionic or anionic dispersants. Suitable nonionic dispersants which may be mentioned are, in particular, ethylene oxide/propylene oxide block polymers, alkylphenol polyglycol ethers and tristyrylphenol polyglycol ethers, and their phosphated or sulphated derivatives. Suitable anionic dispersants are, in particular, lignosulphonates, polyacrylic acid salts and arylsulphonate/formaldehyde condensates.

Antifoams which can be used for formulating the powders according to the invention are all those materials which inhibit foaming and which are suitable for the formulation of agrochemical active compounds. Materials which can preferably be used are silicon antifoams and magnesium stearate.

Preservatives which can be used for formulating the powders according to the invention are all those substances which are conventionally used for such purposes for the formulation of agrochemical active compounds. Examples which may be mentioned are dichlorophene and benzyl alcohol hemiformal.

Possible humectant components and antifreeze agents which can be used for formulating the powders according to the invention are all those materials which can be employed for such purposes in agrochemical compositions. Substances which can preferably be used are polyhydric alcohols such as glycerol, ethanediol, propanediol and polyethylene glycols of various molecular weights.

Suitable secondary thickeners which can be used for formulating the powders according to the invention are all substances which can be employed for such purposes in agrochemical compositions. Possible substances are, preferably, cellulose derivatives, acrylic acid derivatives, xanthan, modified clays and highly dispersed silica.

Possible solvents which can be used for formulating the powders according to the invention are all organic solvents which can be employed in agrochemical compositions. Substances which are preferably suitable are ketones such as methyl isobutyl ketone and cylohexanone, furthermore amides, such as dimethylformamide, moreover cyclic compounds such as N-methyl-pyrrolidone, N-octyl-pyrrolidone, N-dodecyl-pyrrolidone, N-octyl-caprolactam, N-dodecyl-caprolactam and y-butyrolactone, in addition strongly polar solvents such as dimethylsulfoxide, furthermore aromatic hydrocarbons such as xylene, or else esters such as propylene glycol monomethyl ether acetate, dibutyl adipate, hexyl acetate, heptyl acetate, tri-n-butyl citrates, diethyl phthalate and di-n-butyl phthalate, and, moreover, alcohols such as ethanol, n- and i-propanol, n- and i-butanol, n- and i-amyl alcohol, benzyl alcohol and 1-methoxy-2-propanol. Water may also be employed as diluent.

If it is intended to prepare seed-dressing products, stickers may also be employed for formulating the powders according to the invention. Suitable materials are all customary binders which can be employed in seed-dressing products. Materials which may preferably be mentioned are polyvinylpyrrolidone, polyvinyl acetate, polyvinyl alcohol and tylose.

Especially preferred as stickers are also dispersions of biodegradable polyester/polyurethane/polyureas in water. Such dispersions are known (cf. WO 01-17347).

The powder formulations according to the invention, either as such or else after mixing with further formulation auxiliaries and/or plant treatment agents and, if appropriate, after further dilution with water, can be employed in practice. They are applied by customary methods, that is to say for example by broadcasting, pouring, spraying or atomizing.

It is especially advantageous to convert the powders according to the invention, by adding suitable formulation auxiliaries and, if appropriate, diluents, into seed-dressing products with which a wide range of seed can be treated. Thus, such seed-dressing products are suitable for dressing the seed of cereals such as wheat, barley, rye, oats and triticale, and of the seed of rice, maize, oilseed rape, peas, field beans, cotton, sunflowers and beet, or else the widest possible range of vegetable seed. The seed-dressing product formulations may also be employed for dressing the seed of transgenic plants. In this context, synergistic effects may be observed in combination with the substances formed by expression.

Suitable mixing apparatus for treating the seed with the seed-dressing product formulations are all those which can conventionally be employed for the treatment of seed. Specifically, seed-dressing is done by introducing the seed into a mixer, adding the desired amount of seed-dressing product formulations either as such or after previously diluting them with water, and mixing until the formulation is distributed uniformly on the seed. If appropriate, this is followed by a drying process.

The powder formulations according to the invention and the formulations which can be prepared therefrom by further mixing with formulation auxiliaries and/or plant treatment compositions are outstandingly suitable for applying agrochemical active compounds to plants and/or their environment. They ensure that the active components are released over a prolonged period in the specific amount desired.

The rate of application of the powder formulations according to the invention and of the preparations which can be prepared therefrom by further mixing with formulation auxiliaries can be varied within a substantial range. It depends on the agrochemical active compounds which are present in each case, their content in the plant treatment compositions, the indication in question, and the field of application.

The preparation and the use of the powder formulations according to the invention is illustrated by the examples which follow.

### PREPARATION EXAMPLES

A) Preparation of Styrene/Acrylonitrile Copolymers

### Example 1

Preparation by Means of Bead Polymerization

A 5 l pressurized stainless-steel vessel (desired pressure: 2.5 Mpa) equipped with paddle stirrer, thermometer, heating and cooling jacket and charge and discharge tube is charged with 1.5 l of desalinated water, 950 g (9.1 mol) of styrene, 330 g (6.2 mol) of acrylonitrile, 16 g of 4-isopropenyl-1-methylcyclohexane (dipentene) as regulator, 0.5 g of di-tert-butylperoxide, 15 g of poly(1-vinyl-2-pyrrolidone) and 7.5 g of poly(vinyl alcohol) and 0.5 g of disodium phosphate. The vessel is flushed repeatedly with nitrogen, and the contents are dispersed with stirring (200 rpm). After 15 minutes, the temperature is raised to 125° C. in the course of 60 minutes and the mixture is stirred for 4 hours at this temperature. The temperature is then raised to 140° C. and held for 4 hours at this temperature. The mixture is cooled, the pressure is released and the vessel is emptied. The bead-shaped product is filtered through a cloth, washed with dilute aqueous hydrochloric acid and subsequently with water and dried for 24 hours at 50° C. under reduced pressure. This gives 1 200 g (93.8% of theory) of styrene/acrylonitrile copolymer with an acrylonitrile content of 25% by weight.

Intrinsic viscosity: 0.83 (MEK, 30° C.)

Molecular weight: 1.8·10⁵ g·mol⁻¹

### Example 2

Preparation by Means of Emulsion Polymerization

In a 2 l round-bottomed flask equipped with stirrer, reflux condenser, thermometer and nitrogen inlet, 635 g of desalinated water, 4 g of sodium dodecane sulphate, 1.0 g of potassium peroxodisulphate and 0.7 g of sodium hydrogen carbonate and 170 mg of tert-dodecanethiol (regulator) are dissolved, and the flask is flushed with nitrogen and heated to 60° C. A mixture of 252 g (2.4 mol) of styrene and 84 g (1.6 mol) of acrylonitrile (both stabilizer-free) is separately prepared under nitrogen. 17 g of this (=5% of the mixture) are added to the aqueous phase in one portion. The flask is then again heated to 60° C., and the remainder of the monomer mixture is added dropwise in the course of 3 hours. The contents of the flask are poured into 5 litres of a vigorously stirred 5% by weight strength aqueous magnesium sulphate solution. The resulting solid product is filtered off with suction and washed first with dilute sulphuric acid and then with desalinated water until neutral. This gives 305 g (92.5% of theory) of styrene/acrylonitrile copolymer with an acrylonitrile content of 27% by weight.

Intrinic viscosity: 1.90 (MEK, 30° C.)

Molecular weight 6.3·10⁵ g·mol⁻¹

### Example 3

Preparation by Means of Solution Polymerization (Industrial Process)

A solution of 49 parts by weight of styrene, 21 parts by weight of acrylonitrile and 30 parts by weight of ethylbenzene is fed continuously to a pressurized stirred vessel. The same amount of product is also discharged continuously at the bottom of the vessel.

The heat of reaction is dissipated by evaporative cooling (reaction temperature: 150° C.; operating pressure: 0.3 Mpa). The conversion rate amounts to 20-30%. The reaction melt is freed from volatile constituents at 230° C. at several pressure levels (500 Torr/66 kPa; 100 Torr/13 kPa) and worked up in a vented extruder. The volatile constituents are recirculated. Depending on the choice of the reaction temperature and the filling level in the reaction vessel, throughput and molecular weight can be influenced within wide limits and independently of one another by addition of molecular weight regulators (tert-dodecanethiol, terpinols and the like). This gives a styrene/acrylonitrile copolymer with an acrylonitrile content of 30% by weight.

Characteristics of Styrene/Acrylonitrile Copolymers

The most important characteristics of styrene/acrylonitrile copolymer (styrene:acrylonitrile =75:25) which can be used in accordance with the invention are compiled in Table 2 which follows.

TABLE 2

| Characteristic | Dimension | Numerical value | Measuring method |
|---|---|---|---|
| Density (25° C.) | g cm⁻³ | 1.080 | DIN 53 479 |
| Volume expansion | k⁻¹ · 10⁻⁴ | | DIN 53 752 |
| coefficient | | | |
| Thermal | WK⁻¹ m⁻¹ | 0.17 | DIN 52 612 |
| conductivity | | | |
| Refractive index | — | 1.569 | — |
| Glass transition | ° C. | 102 | — |
| temperature | | | |
| Modulus of | N mm⁻² | 3700 | DIN 53 457 |
| elasticity (tensile | | | |
| experiment) | | | |
| Ball indentation | N mm⁻² | 165 | DIN 53 456 |
| hardness | | | |
| Rockwell hardness | degree | M 83 | ISO 2039/2 |
| Dielectric constant | — | 2.7 | DIN 53 483 |
| (1 MHz) | | | |

B Preparation of Powder Formulations According to the Invention

### Example 4

In a laboratory-scale kneader (Rheomix 300 E from Haake) 270 g of styrene-acrylonitrile copolymer with an acrylonitrile content of 28% by weight are melted at 190° C. 116 g of imidacloprid are introduced into this melt portionwise at 190° C. The mixture is subsequently kneaded for 10 minutes at 170° C. to 190° C. until a clear melt results, which is discharged from the kneader while hot and spread over a Teflon tray. The resin, which is clear and nonsticky at room temperature, is comminuted and ground finely in a ball mill. Scanning electron microscopy reveals particles of a size of from approx. 0.2 to 50 μm. The pulverulent, polymer-bound plant treatment composition consists of 28.9 parts by weight of imidacloprid and 71.1 parts by weight of styrene/acrylonitrile copolymer.

### Example 5

9 kg of imidacloprid and 21 kg of styrene/acrylonitrile bead polymer with an acrylonitrile content of 30% by weight are mixed intimately and the mixture is subsequently fed continuously to a twin-screw extruder ZSK 32 (Werner and Pfleiderer) at 160° C. at a rate of 5 kg/h, using a metering device. A homogenous product extrudate of approximate diameter 2 mm is continuously discharged from the extruder nozzle. This extrudate is first cooled in a water bath and then comminuted in a granulator to give cylindrical particles with a length of approx. 4 mm. The resulting granules consist to 29% by weight of imidacloprid and to 71% by weight of styrene/acrylonitrile copolymer. Prior to use, the product is ground to the desired particle size with the aid of a ball mill.

### C) Use Examples

### Example 6

Release of Active Compound

3531.5 mg of the powder of Example 4 are stirred in 1 litre of Cipac 500 ppm water (=Standard Water C) at 25° C. The imidacloprid amounts to 28.9% by weight of the powder employed. Accordingly, the initial weight of imidacloprid is 1020.6 mg. Imidacloprid has a solubility in water of approximately 700 mg/litre at 25° C. Samples are taken from the stirred mixture after the stirring times indicated in Table 3 hereinbelow and are filtered through a 0.2 μm microfilter. The imidacloprid concentration is determined in each of the filtrates. The active compound concentration is determined by means of HPLC:

TABLE 3

| Sampling after [h] | Imidacloprid content in |
|---|---|
| stirring | the sample [mg/l] |
| 0.25 | 7.20 |
| 1 | 9.98 |
| 6 | 13.61 |
| 24 | 27.26 |
| 48 | 39.45 |
| 72 | 48.97 |
| 168 | 54.67 |
| 336 | 64.7 |
| 504 | 70.3 |
| 864 | 80.2 |

The data reveal that the powder formulation according to the invention releases the active compound in a controlled manner over a prolonged period.

### Example 7

Rice Seed Dressing

3.34 g of the powder formulation of Example 4 are stirred with 12 g of water, 0.4 g of sticker (Impranil DLN W50, Bayer AG) and 1 g of a 1% by weight strength aqueous solution of the colorant LEVANYL RED BB-LF (Bayer AG) to give a seed-dressing fluid. This is applied to 200 g of dehusked rice kernels cv. KOSHIHIKARA. The rice kernels treated in this way are subsequently moved by hand in a dish until the individual rice kernels no longer adhere to each other. The dressed seed is then dried for 16 hours at 40° C. All rice kernels are coated. No abrasion is observed.

### Example 8

Release of Active Compound

204 g of coated rice of Example 7 are stirred into 1 l of CIPAC 500 ppm water (=standard water C) at 25° C. The initial weight of imidacloprid is 1 000 mg. Imidacloprid has a solubility in water of approx. 700 mg/litre at 25° C. After the intervals shown in Table 4, samples are taken from the stirred mixture and filtered through a 0.2 μm microfilter, and the active compound content is determined by HPLC.

TABLE 4

| Sampling after a stirring | Imidacloprid content in |
|---|---|
| time of [h] | the sample [mg/l] |
| 1 | 7.37 |
| 6 | 13.1 |
| 24 | 19.2 |

### Example 9

Rice Seed Dressing

1.67 g of the powder formulation of Example 4 and 2.5 g of a commercially available carpropamid formulation with a carpropamid content of 40% by weight are stirred with 4 g of water, 0.2 g of sticker (Impranil DLN W50, Bayer AG) and 1 g of a 1% by weight strength aqueous solution of the colorant LEVANYL RED BB-LF (Bayer AG) to give a seed-dressing fluid. This is applied to 100 g of dehusked rice kernels cv. KOSHIHIKARA. The rice kernels treated in this way are subsequently moved by hand in a dish until the individual rice kernels no longer adhere to each other. The dressed seed is then dried for 16 hours at 40° C. All rice kernels are coated. No abrasion is observed.

### Example 10

Rice Seed Dressing

In a vibrating seed-treater, batches of 18.5 g of rice kernels cv. Koshihikari dehusked are treated with each 200 μl of water in three different set-ups. Thereafter, in each case 55.5 μl of sticker (Impranil DLN D50, Bayer AG) are added. Immediately thereafter, the batches treated thus are mixed separately and with rotation

a) with 123.3 mg,

b) with 246.7 mg or

c) with 616.7 mg

of powder formulation as described in Example 4. This gives treated seed in which the active compound concentration is

a) 200 g per 100 kg of seed,

b) 400 g per 100 kg of seed and

c) 1000 per 100 kg of seed,

respectively. All rice kernels are coated. No abrasion is observed.

### Example 11

Tolerance Test
In each case 18.5 g treated rice kernels of each of the three samples prepared as described in Example 10 and
in each case 18.5 g of rice kernels which had been treated in the same manner with a commercially available liquid imidacloprid seed treatment formulation,

are in each case evenly sown into dishes 17 cm×13 cm in size whose bottom is covered with 4 cm of screened and steamed field soil. The rice kernels are subsequently covered with 1 cm of soil.

The dishes are then placed into a chamber in which the relative air moisture is 90% and in which a daytime temperature of 24° C. and a nighttime temperature of 15° C. prevails.

After the periods stated in Table 5 hereinbelow post-sowing, the plants are examined for damage. Features which are determined are necroses, yellowing, abnormal growth and deformation. The total of all symptoms of damage is expressed in percent. 0% means that no damage is observed, while 400% means that the plants are completely damaged.

TABLE 5
Tolerance test

| | | Application rate | Total damage in % after | | |
|---|---|---|---|---|---|
| Formulation | | of active compound | 15 | | |
| of example | | g of a.i./100 kg seed | days | 22 days | 29 days |
| according to the | | | | | |
| invention: | | | | | |
| Example 10 | a) | 200 | 10 | 15 | 15 |
| | b) | 400 | 5 | 10 | 15 |
| | c) | 1000 | 5 | 10 | 20 |

| | | | | |
|---|---|---|---|---|
| known: | | | | |
| Imidacloprid | 200 | 10 | 10 | 25 |
| seed treatment product*) | 400 | 15 | 10 | 40 |
| | 1000 | 35 | 60 | 75 |
| Control | 0 | 2.5 | 10 | 20 |
| (untreated) | | | | |

*)Commercially available formulation

1. Powder formulations consisting of
at least one agrochemical active compound,
at least one copolymer of styrene and acrylonitrile with an acrylonitrile content of between 20 and 40% by weight, and,
if appropriate, additives
and which have a particle diameter of under 125 μm.

2. Powder formulations according to claim 1, characterized in that a copolymer of styrene and acrylonitrile with an acrylonitrile content of between 25 and 35% by weight is present.

3. Powder formulations according to claim 1, characterized in that the agrochemical active compounds present are imidacloprid and/or carpropamid.

4. Powder formulations according to claim 1, characterized in that
the content of agrochemical active compounds generally amounts to between 1 and 50% by weight,
the content of styrene/acrylonitrile copolymers amounts to between 50 and 99% by weight, and
the additive content amounts to between 0 and 30% by weight.

5. Process for the preparation of powder formulations as claimed in claim 1, characterized in that a mixture of
at least one agrochemical active compound,
at least one copolymer of styrene and acrylonitrile with an acrylonitrile content of between 20 and 40% by weight, and,
if appropriate, additives
is homogenized at temperatures of between 120° C. and 230° C. in the melt and the mixture is comminuted after cooling in such a way as to obtain a powder in which the particles have a diameter under 125 μm.

6. The use of powder formulations according to claim 1 for applying the agrochemical active compounds present to plants and/or their environment.

7. Process for the preparation of plant treatment compositions, characterized in that powder formulations according to claim 1 are mixed with extenders and/or surfactants.

8. Plant treatment composition, characterized in that it contains a powder formulation according to claim 1 in addition to extenders and/or surfactants.
